(19) United States
(12) Patent Application Publication
(10) Pub. No.: US 2023/0113162 A1
(43) Pub. Date: Apr. 13, 2023

(54) ROTARY ELECTRIC MACHINE

(71) Applicant: Mitsubishi Electric Corporation, Tokyo (JP)

(72) Inventors: Tadashi MURAKAMI, Tokyo (JP); Hiroyuki Higashino, Tokyo (JP); Jun Tahara, Tokyo (JP); Shota Morikawa, Tokyo (JP); Yoshinobu Utsumi, Tokyo (JP); Yosuke Uno, Tokyo (JP)

(73) Assignee: Mitsubishi Electric Corporation, Tokyo (JP)

(21) Appl. No.: 17/727,156

(22) Filed: Apr. 22, 2022

(30) Foreign Application Priority Data
Oct. 13, 2021 (JP) 2021-167867

(51) Int. Cl. H02K 9/00; H02K 1/22; H02K 5/20; H02K 11/33

(52) U.S. Cl. CPC H02K 9/00; H02K 1/22; H02K 5/20; H02K 11/33

(57) ABSTRACT

This rotary electric machine includes: an electric motor; a power supply unit including a heat-dissipation member, a power module, and a cover covering the heat-dissipation member and the power module; and a coolant path. A connection portion connecting the electric motor and the power supply unit is provided between the housing and the power supply unit. A cylindrical portion of the cover extends toward the one side in the axial direction and covers the connection portion from the radially outer side. The coolant path is provided at one or both of the heat-dissipation member and an area between the heat-dissipation member and the housing. The coolant path overlaps the power module as seen in the axial direction. The cylindrical portion of the cover has an opening through which a coolant passes, at a circumferential-direction position different from a circumferential-direction position on the radially outer side of the connection portion.

### BACKGROUND OF THE INVENTION

### 1. Field of the Invention

The present disclosure relates to a rotary electric machine.

### 2. Description of the Background Art

A vehicular rotary electric machine includes, in addition to an electric motor, a power supply unit having a power circuit for controlling the electric motor. For the vehicular rotary electric machine, space-saving design, ease of mounting, size reduction of a wiring harness connecting the electric motor and the power supply unit, and the like, are required. Therefore, a control-device-integrated rotary electric machine which is a rotary electric machine in which an electric motor and a power supply unit are integrated is being developed.

In addition, a control-device-integrated rotary electric machine mounted in a hybrid vehicle (HV) or the like is required to have high cooling performance. In a case where temperature increase in the control-device-integrated rotary electric machine is great, it is necessary to reduce the current density in the control-device-integrated rotary electric machine, so that performance of the control-device-integrated rotary electric machine is lowered. In a vehicular AC electric generator in which an electric motor and a rectifier are integrated, a structure for improving cooling performance for the electric motor and the rectifier is disclosed (see, for example, Patent Document 1). In the disclosed structure, a rotary electric machine has a fan fixed to both end surfaces of a rotor, and a rectifier heatsink having a flow path made of a material having high thermal conductivity is provided at a side surface of a bracket. A coolant flows through the flow path from the outside. Further, a flow path is defined by the bracket and an opening of a protection cover.
Patent Document 1: Japanese Laid-Open Patent Publication No. 3-178540

In Patent Document 1, the rectifier can be cooled by the flowing coolant. However, in a case of applying the disclosed structure to a control-device-integrated rotary electric machine, since the opening of the protection cover is large, brine mud water enters the inside of the rotary electric machine when the rotary electric machine is watered, thus having a problem that the inside of the rotary electric machine is likely to be corroded. In addition, a component for protecting an electrified portion is needed for suppressing corrosion. Therefore, there is a problem that the cost for the rotary electric machine increases and the rotary electric machine increases in size and thus in weight.

In particular, in a case where a rotary electric machine is mounted in an engine room of a vehicle, it is required that the rotary electric machine can be placed in a limited space. In a vehicle type in which only a slight space can be ensured in the radial direction of the rotary electric machine, there are disadvantages that components interfere with each other and a working space for attaching a connector for connection to an external device and fixation screws cannot be ensured. In a worst case, the rotary electric machine cannot be accommodated in the space, so that the rotary electric machine cannot be mounted. As described above, depending on the layout in the engine room, there are constraints on mounting of the rotary electric machine, thus having a problem that the rotary electric machine cannot be increased in size. In addition, in order to avoid reduction in performance of the rotary electric machine due to temperature increase in the rotary electric machine, components having high heat resistance need to be used in the rotary electric machine, thus having a problem of increasing the cost for the rotary electric machine.

### SUMMARY OF THE INVENTION

Accordingly, an object of the present disclosure is to provide a rotary electric machine that is high in waterproofness, low in cost, and small in size while keeping the cooling performance for an electric motor and a power supply unit.

A rotary electric machine according to the present disclosure includes: an electric motor including a rotor which has a field core wound with a field winding and rotates integrally with a rotary shaft, a stator provided on a radially outer side of the rotor and having a stator core wound with a stator winding, and a housing covering outer sides of the field core and the stator core and retaining one end side and another end side of the rotary shaft via bearings; a power supply unit including a heat-dissipation member which is formed in a plate shape and of which a surface on one side in an axial direction is located on another side in the axial direction of the housing, a power module which has a power semiconductor element for turning on and off supply of current to the stator winding and of which a surface on the one side in the axial direction is thermally connected to a surface on the other side in the axial direction of the heat-dissipation member, and a cover formed in a bottomed cylindrical shape and covering the heat-dissipation member and the power module from the other side in the axial direction and a radially outer side, the power supply unit being located on the other side in the axial direction of the housing; and a coolant path. A connection portion electrically connecting the electric motor and the power supply unit is provided between the housing and the power supply unit. A cylindrical portion which is a cylindrical part of the cover extends toward the one side in the axial direction and covers the connection portion from the radially outer side. The coolant path is provided at one or both of the heat-dissipation member and an area between the heat-dissipation member and the housing. At least a part of the coolant path overlaps the power module as seen in the axial direction. The cylindrical portion of the cover has at least one opening through which a coolant of the coolant path passes, at a circumferential-direction position different from a circumferential-direction position on the radially outer side of the connection portion.

In the rotary electric machine according to the present disclosure, the connection portion electrically connecting the electric motor and the power supply unit is provided between the housing and the power supply unit. The cylindrical portion of the cover extends toward the one side in the axial direction and covers the connection portion from the radially outer side. The coolant path is provided at one or both of the heat-dissipation member and an area between the heat-dissipation member and the housing. At least a part of the coolant path overlaps the power module as seen in the axial direction. The cylindrical portion of the cover has at least one opening through which a coolant of the coolant path passes, at a circumferential-direction position different from a circumferential-direction position on the radially outer side of the connection portion. Thus, the part between the housing and the power supply unit is covered by the cylindrical portion from the radially outer side, except for the opening part, whereby entry of water and a foreign material from the outside into the rotary electric machine can be hindered without addition of a protection component. Thus, it is possible to provide a rotary electric machine that is high in waterproofness, low in cost, and small in size while keeping the cooling performance by the coolant path.

### BRIEF DESCRIPTION OF THE DRAWINGS

FIG. 1 is a perspective view schematically showing a rotary electric machine according to the first embodiment of the present disclosure;

FIG. 2 is a sectional view schematically showing the rotary electric machine according to the first embodiment of the present disclosure;

FIG. 3 is a sectional view of the rotary electric machine taken at an A-A cross-section position in FIG. 2;

FIG. 4 is a sectional view schematically showing another rotary electric machine according to the first embodiment;

FIG. 5 is a sectional view schematically showing another rotary electric machine according to the first embodiment;

FIG. 6 is a sectional view schematically showing a rotary electric machine according to the second embodiment of the present disclosure;

FIG. 7 is a sectional view of the rotary electric machine taken at a B-B cross-section position in FIG. 6;

FIG. 8 is a plan view showing a heat-dissipation member of a rotary electric machine according to the third embodiment of the present disclosure;

FIG. 9 is a plan view showing a heat-dissipation member of a rotary electric machine according to the fourth embodiment of the present disclosure;

FIG. 10 is a perspective view showing a heat-dissipation member of a rotary electric machine according to the fifth embodiment of the present disclosure; and

FIG. 11 is a perspective view showing a heat-dissipation member of a rotary electric machine according to the sixth embodiment of the present disclosure.

### DETAILED DESCRIPTION OF THE PREFERRED

### Embodiments of the Invention

Hereinafter, rotary electric machines according to embodiments of the present disclosure will be described with reference to the drawings. In the drawings, the same or corresponding members and parts are denoted by the same reference characters, to give description. In the drawings, the sizes or the scales of the corresponding constituent parts are independent of each other.

### First Embodiment

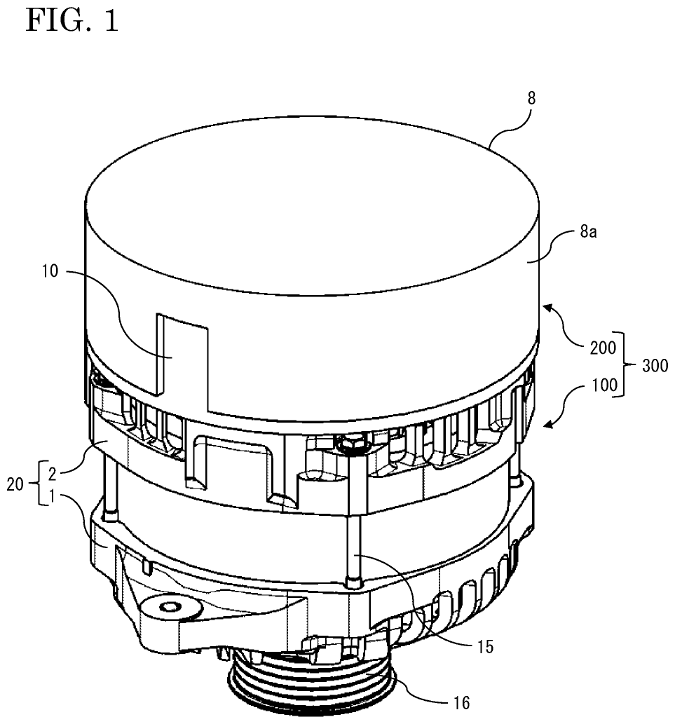

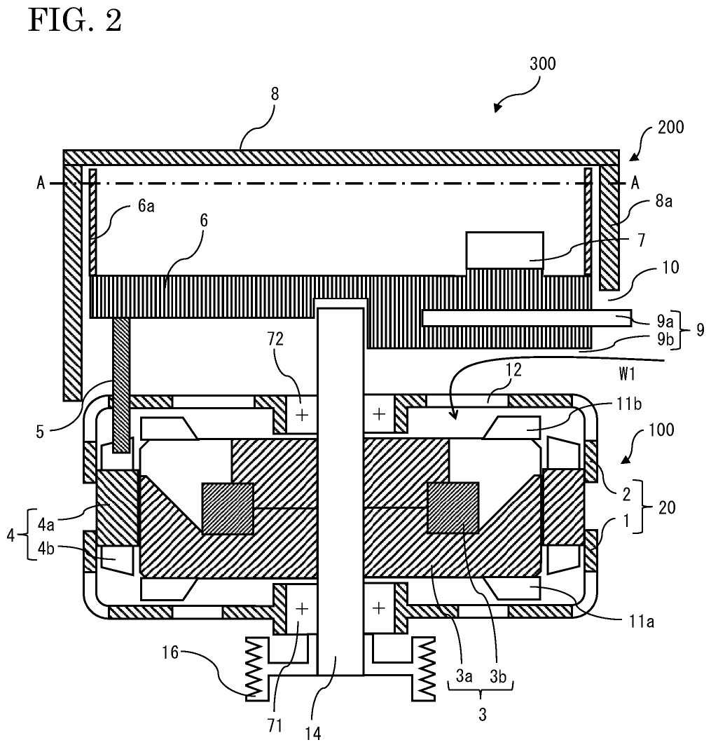

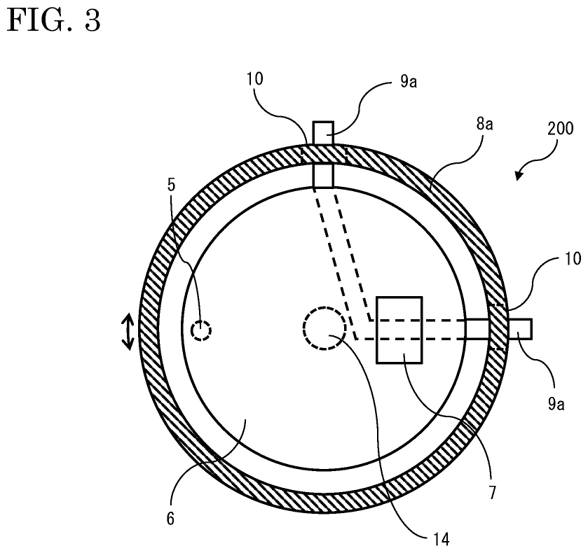

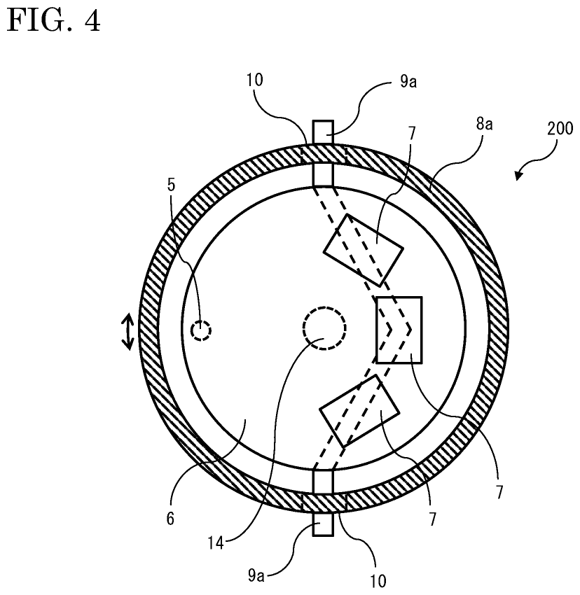

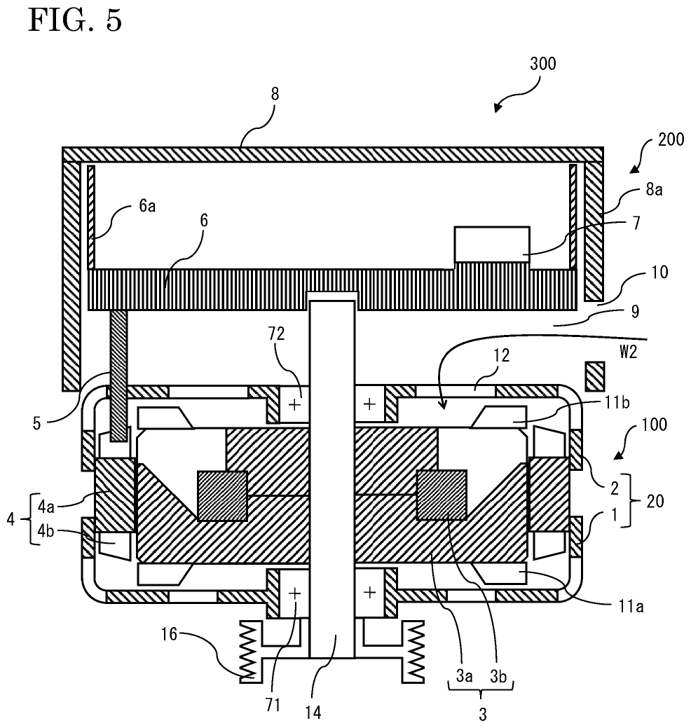

FIG. 1 is a perspective view schematically showing a rotary electric machine 300 according to the first embodiment. FIG. 2 is a sectional view schematically showing the rotary electric machine 300 when the rotary electric machine 300 is cut along the axial direction. FIG. 3 is a sectional view of the rotary electric machine 300 taken at an A-A cross-section position in FIG. 2. FIG. 4 is a sectional view schematically showing another rotary electric machine 300 according to the first embodiment, taken at a position equivalent to that in FIG. 3. FIG. 5 is a sectional view schematically showing another rotary electric machine 300 according to the first embodiment when the rotary electric machine 300 is cut along the axial direction. In FIG. 3 and FIG. 4, an outer circumferential wall 6a of a heat-dissipation member 6 is not shown. As shown in FIG. 1, the rotary electric machine 300 is a control-device-integrated rotary electric machine including an electric motor 100 which is a rotary electric machine main part, and a power supply unit 200 which is a control device.

The electric motor 100 includes a rotor 3 and a stator 4 and drives an engine (not shown) which is a load. Alternatively, the electric motor 100 serves as an electric generator which generates power while being driven by the engine. The power supply unit 200 is provided on another side in the axial direction of a housing 20 that the electric motor 100 has, and controls power to be supplied to the electric motor 100. The power supply unit 200 is fixed to the electric motor 100, and the electric motor 100 and the power supply unit 200 are integrated with each other.

<Electric Motor 100>

As shown in FIG. 2, the electric motor 100 includes the rotor 3 which rotates integrally with a shaft 14 as a rotary shaft, the stator 4 provided on the radially outer side of the rotor 3, and the housing 20 storing these and rotatably retaining the shaft 14. The rotor 3 is provided so as to be rotatable coaxially with the stator 4.

The rotor 3 has a field winding 3b and a field core 3a wound with the field winding 3b. The stator 4 includes stator windings 4b for a plurality of phases, and a stator core 4a wound with the stator winding 4b. The stator windings 4b for the plurality of phases may be, for example, one pair of three-phase windings or two pairs of three-phase windings. However, without limitation thereto, the stator windings 4b are set in accordance with the type of the rotary electric machine 300. The housing 20 covers the outer sides of the field core 3a and the stator core 4a.

The housing 20 includes a load-side bracket (hereinafter, referred to as a front bracket 1) provided on the load side and a non-load-side bracket (hereinafter, referred to as a rear bracket 2) provided on the non-load side. The front bracket 1 retains one end side of the shaft 14 via a bearing 71, and covers the front side which is one side of the rotor 3 and the stator 4. The rear bracket 2 retains the other end side of the shaft 14 via a bearing 72, and covers the rear side which is the other side of the rotor 3 and the stator 4. The stator 4 is supported and fixed by the front bracket 1 and the rear bracket 2. The housing 20 has at least one coolant inlet 12 through which the coolant flows in, at a wall on the other side in the axial direction of the rear bracket 2. The coolant inlet 12 is a hole penetrating the wall. The front bracket 1 and the rear bracket 2 are provided with an interval therebetween in the axial direction, and are connected by bolts 15 extending in the axial direction as shown in FIG. 1.

The shaft 14 is provided with a pulley 16 at an end on the one end side of the shaft 14 protruding from a through hole of the front bracket 1. The pulley 16 and a rotary shaft of the engine are connected via a belt (not shown), whereby the pulley 16 transmits rotational energy to the engine.

As shown in FIG. 2, a fan 11a is fixed to an end surface on the front side which is one side in the axial direction of the field core 3a of the rotor 3. A fan 11b is fixed to an end surface on the rear side which is the other side in the axial direction of the field core 3a of the rotor 3. The fan 11a and the fan 11b rotate integrally with the rotor 3.

<Power Supply Unit 200>

The power supply unit 200 includes the heat-dissipation member 6, a power module 7, and a cover 8. Wiring 5 which is a connection portion electrically connecting the electric motor 100 and the power supply unit 200 is provided between the housing 20 and the power supply unit 200. The heat-dissipation member 6 is formed in a plate shape and a surface thereof on one side in the axial direction is located on the other side in the axial direction of the housing 20. The heat-dissipation member 6 is formed from a metal plate member or a die casting product of metal such as an aluminum alloy or a copper alloy, for example. The heat-dissipation member 6 serves to dissipate heat generated when current flows in the power supply unit 200, to the outside. Further, the heat-dissipation member 6 has the outer circumferential wall 6a surrounding the power module 7 from the radially outer side. The outer circumferential wall 6a is made of a resin material having insulating property, for example.

The power module 7 has a power semiconductor element for turning on and off current to be supplied to the stator winding 4b. One or more pairs of power semiconductor elements forming upper and lower arms are provided to the power module 7, and a power circuit portion is formed by a plurality of power modules 7. The power circuit portion may be formed by one power module 7 with a plurality of pairs of power semiconductor elements provided to the power module 7. A surface on one side in the axial direction of the power module 7 is thermally connected to the surface on the other side in the axial direction of the heat-dissipation member 6. The power semiconductor elements are arranged on a lead frame forming electric wiring and are sealed by a resin material together with the surrounding circuitry, for example.

The cover 8 is formed in a bottomed cylindrical shape and covers the heat-dissipation member 6 and the power module 7 from the other side in the axial direction and the radially outer side. The cover 8 is formed by a metal plate or die casting using metal such as iron or aluminum, for example. The material of the cover 8 is not limited to metal, and may be made of a resin material. In a case where the cover 8 is made of metal, entry of noise from the outside into the power supply unit 200 can be hindered. Since entry of noise into the power supply unit 200 is hindered, performance of the power supply unit 200 can be improved.

A cylindrical portion 8a which is a cylindrical part of the cover 8 extends toward one side in the axial direction and covers the wiring 5 from the radially outer side. With this structure, the wiring 5 part is prevented from being watered, whereby corrosion of the wiring 5 can be suppressed.

The cylindrical portion 8a of the cover 8 has at least one opening 10 through which a coolant of a coolant path 9 described later passes, at a circumferential-direction position different from a circumferential-direction position on the radially outer side of the wiring 5. The circumferential-direction position on the radially outer side of the wiring 5 is a position indicated by an arrow on the outer side of the cylindrical portion 8a in FIG. 3. In the present embodiment, two openings 10 are provided as shown in FIG. 3. The number of the openings 10 is not limited to two, and may be one, or three or more. With this structure, the part between the housing 20 and the power supply unit 200 is covered by the cylindrical portion 8a from the radially outer side, except for the opening 10 part. Thus, entry of water and a foreign material from the outside into the rotary electric machine 300 can be hindered, whereby the waterproofness of the rotary electric machine 300 can be improved without addition of a protection component. Since no protection components are added, the cost and the size of the rotary electric machine 300 can be reduced.

As shown in FIG. 1, the opening 10 is a cutout formed by cutting the cylindrical portion 8a from an end on the one side in the axial direction of the cylindrical portion 8a toward the other side in the axial direction. In this way, the cylindrical portion 8a having the opening 10 can be easily manufactured. Thus, ease of manufacturing and ease of assembly of the cover 8 are improved, whereby the rotary electric machine 300 can be manufactured at low cost and productivity of the rotary electric machine 300 can be improved. The opening 10 is not limited to a cutout, and may be a through hole as shown in FIG. 5.

<Coolant Path 9>

The rotary electric machine 300 has the coolant path 9. The coolant path 9 is provided at one or both of the heat-dissipation member 6 and an area between the heat-dissipation member 6 and the housing 20. In the present embodiment, as shown in FIG. 2, the coolant paths 9 are provided as a first coolant path 9a provided at the heat-dissipation member 6 and a second coolant path 9b provided at an area between the heat-dissipation member 6 and the housing 20. A coolant of the first coolant path 9a cools the power supply unit 200, and a coolant of the second coolant path 9b cools the electric motor 100. In this structure, parts to be cooled by the respective coolants of the first coolant path 9a and the second coolant path 9b are different from each other, so that the cooling efficiency for each part can be improved. In addition, the coolant of the first coolant path 9a and the coolant of the second coolant path 9b pass through the same opening 10. With this structure, while the cooling performance for the electric motor 100 and the power supply unit 200 is kept, the number of the openings 10 can be decreased. Thus, entry of water and a foreign material from the outside into the rotary electric machine 300 can be further hindered, whereby the waterproofness of the rotary electric machine 300 can be improved.

In the present embodiment, the coolant of the first coolant path 9a is liquid or gas, and the coolant of the second coolant path 9b is gas. Along with rotation of the fan 11b, a cooling wind W1 is generated in the second coolant path 9b. The cooling wind W1 passes in the radial direction between the heat-dissipation member 6 and the housing 20. Thereafter, the cooling wind W1 flows into the electric motor 100 through the coolant inlet 12. The coolant having flowed into the electric motor 100 through the coolant inlet 12 cools the rotor 3 and the stator 4 provided inside the electric motor 100. With this structure, the electric motor 100 can be efficiently cooled.

As shown in FIG. 5, the coolant path 9 may be provided at only an area between the heat-dissipation member 6 and the housing 20. The coolant of the coolant path 9 is gas. Along with rotation of the fan 11b, a cooling wind W2 is generated in the coolant path 9. The cooling wind W2 passes in the radial direction between the heat-dissipation member 6 and the housing 20, and the coolant cools the power supply unit 200. Thereafter, the cooling wind W2 flows into the electric motor 100 through the coolant inlet 12. The coolant having flowed into the electric motor 100 through the coolant inlet 12 cools the rotor 3 and the stator 4 provided inside the electric motor 100. In the structure shown in FIG. 5, the number of the openings 10 may be one.

At least a part of the first coolant path 9a overlaps the power module 7 as seen in the axial direction, as shown in FIG. 3. A part indicated by a broken line in FIG. 3 is the first coolant path 9a. Since the first coolant path 9a is provided adjacently to the power module 7 which is a heat source, the cooling efficiency for the power module 7 can be improved.

In FIG. 3, one power module 7 is provided as an example. However, the number of power modules 7 is not limited to one. As shown in FIG. 4, a plurality of power modules 7 may be provided. The plurality of power modules 7 are provided so as to be arranged in the circumferential direction. The first coolant path 9a extends in the circumferential direction so as to overlap the plurality of power modules 7 as seen in the axial direction. With this structure, it is possible to efficiently cool the plurality of power modules 7 by the first coolant path 9a provided within a short distance.

As shown in FIG. 4, the wiring 5 is provided at one location in the circumferential direction. In a case of providing a plurality of wirings 5, the plurality of wirings 5 are collectively provided at one location in the circumferential direction. A part indicated by a broken line in FIG. 4 is the first coolant path 9a. The first coolant path 9a extends in the circumferential direction so as to surround the shaft 14 and the wiring 5 as seen in the axial direction. In this structure, even when a plurality of power modules 7 are provided, the opening 10 can be easily provided at a circumferential-direction position different from a circumferential-direction position on the radially outer side of the wiring 5. Thus, the wiring 5 part can be assuredly prevented from being watered.

As described above, in the rotary electric machine 300 according to the first embodiment, the wiring 5 electrically connecting the electric motor 100 and the power supply unit 200 is provided between the housing 20 and the power supply unit 200, and the cylindrical portion 8a of the cover 8 extends toward one side in the axial direction and covers the wiring 5 from the radially outer side. The coolant path 9 is provided at one or both of the heat-dissipation member 6 and an area between the heat-dissipation member 6 and the housing 20. At least a part of the coolant path 9 overlaps the power module 7 as seen in the axial direction. The cylindrical portion 8a of the cover 8 has at least one opening 10 through which the coolant of the coolant path 9 passes, at a circumferential-direction position different from the circumferential-direction position on the radially outer side of the wiring 5. Thus, the part between the housing 20 and the power supply unit 200 is covered by the cylindrical portion 8a from the radially outer side, except for the opening 10 part, whereby entry of water and a foreign material from the outside into the rotary electric machine 300 can be hindered without addition of a protection component. Thus, it is possible to provide the rotary electric machine 300 that is high in waterproofness, low in cost, and small in size while keeping the cooling performance by the coolant path 9.

In a case where a plurality of power modules 7 are arranged in the circumferential direction and the first coolant path 9a extends in the circumferential direction so as to overlap the plurality of power modules 7 as seen in the axial direction, the plurality of power modules 7 can be efficiently cooled by the first coolant path 9a provided within a short distance. In addition, in a case where the wiring 5 is provided at one location in the circumferential direction and the first coolant path 9a extends in the circumferential direction so as to surround the shaft 14 and the wiring 5 as seen in the axial direction, even when a plurality of power modules 7 are provided, the opening 10 can be easily provided at a circumferential-direction position different from the circumferential-direction position on the radially outer side of the wiring 5. Thus, the wiring 5 part can be assuredly prevented from being watered.

The coolant path 9 may include the first coolant path 9a provided at the heat-dissipation member 6 and the second coolant path 9b provided at an area between the heat-dissipation member 6 and the housing 20, and the coolant of the first coolant path 9a and the coolant of the second coolant path 9b may pass through the same opening 10. In this case, while the cooling performance for the electric motor 100 and the power supply unit 200 is kept, the number of the openings 10 can be decreased. Thus, entry of water and a foreign material from the outside into the rotary electric machine 300 can be further hindered, whereby waterproofness of the rotary electric machine 300 can be further improved. In addition, in a case where the coolant of the first coolant path 9a cools the power supply unit 200 and the coolant of the second coolant path 9b cools the electric motor 100, parts to be cooled by the respective coolants of the first coolant path 9a and the second coolant path 9b are different from each other, so that the cooling efficiency for each part can be improved.

In a case where the opening 10 is a cutout formed by cutting the cylindrical portion 8a from an end on one side in the axial direction of the cylindrical portion 8a toward the other side in the axial direction, the cylindrical portion 8a having the opening 10 can be easily manufactured. Thus, ease of manufacturing and ease of assembly of the cover 8 are improved, whereby the rotary electric machine 300 can be manufactured at low cost and productivity of the rotary electric machine 300 can be improved. In addition, in a case where the cover 8 is made of metal, entry of noise from the outside into the power supply unit 200 can be hindered.

The rotor 3 may have the fan 11b fixed to the end surface on the other side in the axial direction of the field core 3a, and the housing 20 may have, on the other side in the axial direction, at least one coolant inlet 12 through which the coolant flows in. In this case, the coolant having flowed into the electric motor 100 through the coolant inlet 12 cools the electric motor 100, whereby the electric motor 100 can be cooled efficiently.

### Second Embodiment

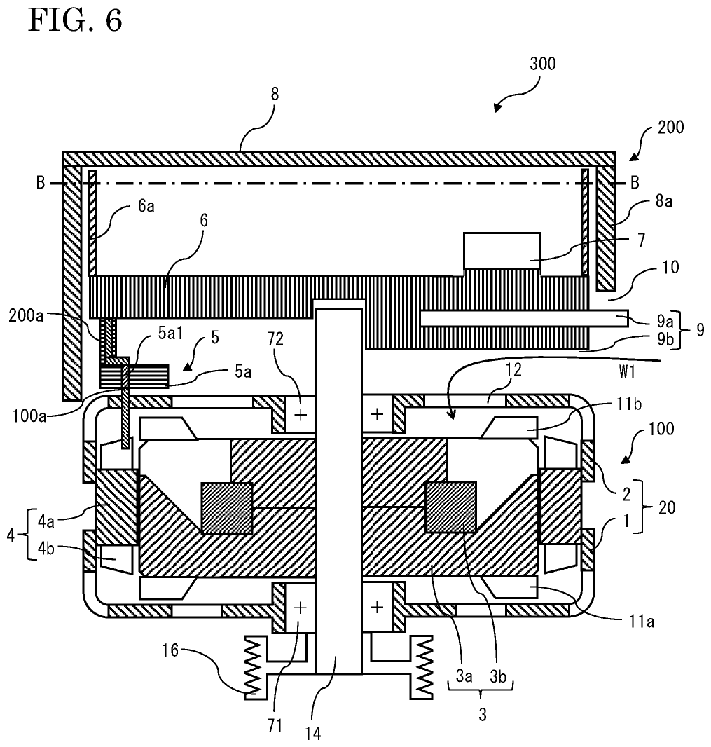

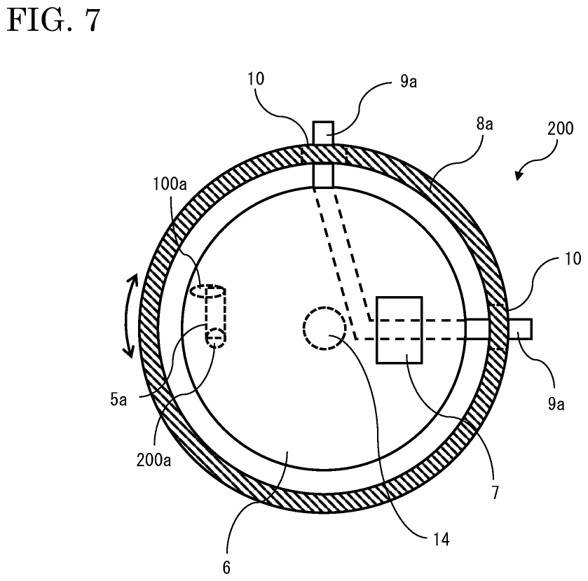

A rotary electric machine 300 according to the second embodiment will be described. FIG. 6 is a sectional view schematically showing the rotary electric machine 300 when the rotary electric machine 300 is cut along the axial direction. FIG. 7 is a sectional view of the rotary electric machine 300 taken at a B-B cross-section position in FIG. 6. In the rotary electric machine 300 according to the second embodiment, the wiring 5 has a power-distribution member 5a.

The wiring 5 has the power-distribution member 5a extending in the circumferential direction. The electric motor 100 and the power supply unit 200 respectively have a terminal portion 100a and a terminal portion 200a which are parts for electrically connecting them. In a case where the terminal portion 100a and the terminal portion 200a are provided at the same circumferential-direction position, the terminal portion 100a and the terminal portion 200a can be directly connected to each other. In a case where the terminal portion 100a and the terminal portion 200a are provided at different circumferential-direction positions, the terminal portion 100a and the terminal portion 200a are connected via the power-distribution member 5a extending in the circumferential direction. The power-distribution member 5a is a member formed by insert molding including a conductive wire Sal for electrically connecting the respective parts. The power-distribution member 5a is provided so that the connection distance between the terminal portion 100a and the terminal portion 200a is shortened. Therefore, the distance by which the power-distribution member 5a extends in the circumferential direction is not greater than the half round length.

The terminal portion 100a and the terminal portion 200a, and the power-distribution member 5a, are connected by welding, for example. The part connected by welding is an electrified part. The opening 10 is provided at a circumferential-direction position different from the circumferential-direction position on the radially outer side of the power-distribution member 5a, in the cylindrical portion 8a. The circumferential-direction position on the radially outer side of the power-distribution member 5a is a position indicated by an arrow on the outer side of the cylindrical portion 8a in FIG. 7. In this structure, the electrified part is not exposed to the outside, and the electrified part is covered by the cylindrical portion 8a from the radially outer side.

As described above, in the rotary electric machine 300 according to the second embodiment, the wiring 5 has the power-distribution member 5a extending in the circumferential direction, and the opening 10 is provided at a circumferential-direction position different from the circumferential-direction position on the radially outer side of the power-distribution member 5a, in the cylindrical portion 8a. Thus, the power-distribution member 5a electrically connecting the electric motor 100 and the power supply unit 200 is covered by the cylindrical portion 8a from the radially outer side, whereby entry of water and a foreign material from the outside into the power-distribution member 5a part can be hindered and waterproofness of the power-distribution member 5a can be improved. In addition, by providing the power-distribution member 5a as a separate member, the electrified part of the power-distribution member 5a can be kept within a substantially half round length, no matter which position in the circumferential direction the terminal portion 100a which is a terminal wire of the stator 4 protrudes from toward the other side in the axial direction. Since the electrified part can be kept within a substantially half round length, the degree of freedom in the position of the opening 10 can be enhanced. Thus, the degree of freedom in arrangement of the coolant path 9 can be enhanced, whereby the cooling effect for the rotary electric machine 300 can be improved.

### Third Embodiment

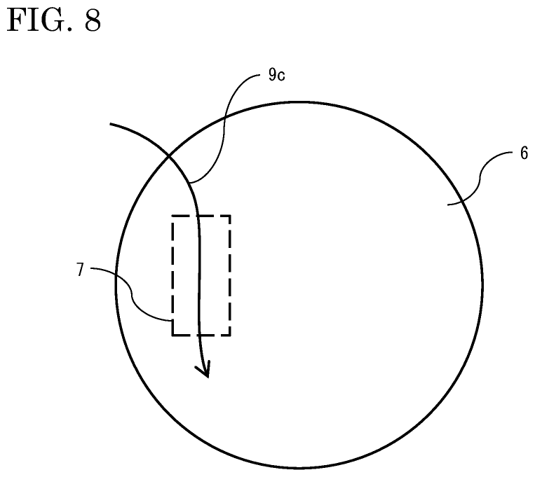

A rotary electric machine 300 according to the third embodiment will be described. FIG. 8 is a plan view showing the heat-dissipation member 6 of the rotary electric machine 300 according to the third embodiment when the heat-dissipation member 6 is viewed from one side in the axial direction. In the rotary electric machine 300 according to the third embodiment, arrangement of the coolant path 9 is further prescribed.

The power module 7 is provided in a polygonal outer shape as seen in the axial direction. In FIG. 8, a part indicated by a broken line is the outer shape of the power module 7. In the third embodiment, the outer shape of the power module 7 is a rectangular shape. However, the outer shape of the power module 7 is not limited thereto and may be another polygonal shape. The coolant path 9 is formed such that, as seen in the axial direction, a center line 9c of the coolant path 9 crosses one side-line of the power module 7 from the outer side of the power module 7, to extend on the inner side of the power module 7, and then crosses another side-line of the power module 7, to extend on the outer side of the power module 7. Arrangement of the coolant path 9 can be prescribed by providing the coolant path 9 at the heat-dissipation member 6. In a case of providing the coolant path 9 at an area between the heat-dissipation member 6 and the housing 20, arrangement of the coolant path 9 can be prescribed by arrangement of the opening 10 and the coolant inlet 12.

As described above, in the rotary electric machine 300 according to the third embodiment, the center line 9c of the coolant path 9 crosses one side-line of the power module 7, to extend on the inner side of the power module 7, and then crosses another side-line of the power module 7. Thus, the coolant path 9 is provided so as to cross the power module 7 which is a heat source to generate a particularly large amount of heat in the power supply unit 200, whereby the power module 7 can be efficiently cooled. Since the power module 7 is efficiently cooled, the cooling efficiency for the power supply unit 200 can be improved.

### Fourth Embodiment

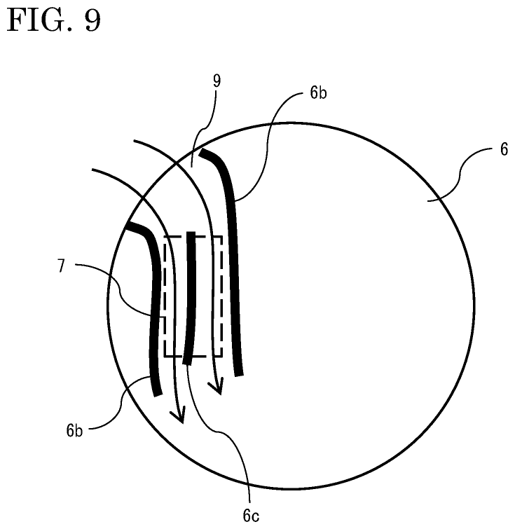

A rotary electric machine 300 according to the fourth embodiment will be described. FIG. 9 is a plan view showing the heat-dissipation member 6 of the rotary electric machine 300 according to the fourth embodiment when the heat-dissipation member 6 is viewed from one side in the axial direction. In the rotary electric machine 300 according to the fourth embodiment, the heat-dissipation member 6 has a side-wall portion 6b.

The heat-dissipation member 6 has two side-wall portions 6b protruding from the surface on one side in the axial direction toward the one side in the axial direction and extending along the coolant path 9, thus forming side walls on both sides of the coolant path 9. The side-wall portion 6b is formed integrally with the heat-dissipation member 6 by the same material as the heat-dissipation member 6, for example. The side-wall portion 6b may be made of a material different from the heat-dissipation member 6 and may be attached to the heat-dissipation member 6. In FIG. 9, a part indicated by a broken line is the outer shape of the power module 7. The coolant path 9 is provided so as to overlap the power module 7 as seen in the axial direction. Arrows shown in FIG. 9 indicate flow of the coolant. The heat-dissipation member 6 may further have, at a part between the two side-wall portions 6b, a protruding portion 6c protruding toward one side in the axial direction and extending along the coolant path 9.

As described above, in the rotary electric machine 300 according to the fourth embodiment, the heat-dissipation member 6 has the side-wall portions 6b extending along the coolant path 9. Thus, the part where the coolant flows is limited to the part where the power module 7 is provided, whereby the power module 7 can be efficiently cooled. In addition, in a case where the heat-dissipation member 6 has the protruding portion 6c, the surface area of the coolant path 9 increases, so that the cooling efficiency for the power module 7 can be further improved.

### Fifth Embodiment

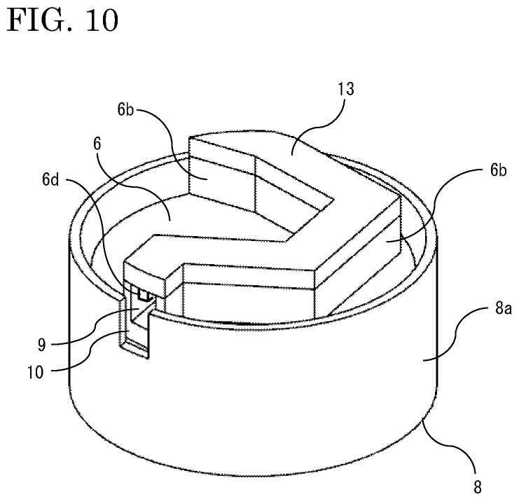

A rotary electric machine 300 according to the fifth embodiment will be described. FIG. 10 is a perspective view showing the heat-dissipation member 6 of the rotary electric machine 300 according to the fifth embodiment, and shows one side in the axial direction. The rotary electric machine 300 according to the fifth embodiment is formed by additionally providing a lid member 13 to the configuration of the rotary electric machine 300 shown in the fourth embodiment.

An opening on one side in the axial direction of the two side-wall portions 6b is covered by the lid member 13. The lid member 13 is made of the same material as the heat-dissipation member 6, for example. The lid member 13 is fixed by welding, ultrasonic joining, or the like so that the coolant path 9 is tightly closed. Fixation of the lid member 13 is not limited thereto. The lid member 13 may be fixed to the side-wall portions 6b by screwing or the like via a seal material. Alternatively, instead of such a configuration that the lid member 13 provided as a separate body is fixed to the heat-dissipation member 6, the lid member 13 and the heat-dissipation member 6 may be formed through integral molding by die casting or the like. The lid member 13 may have at least one projection 6d projecting toward the coolant path 9 side.

As described above, in the rotary electric machine 300 according to the fifth embodiment, the opening on one side in the axial direction of the two side-wall portions 6b is covered by the lid member 13. Thus, as compared to the structure shown in FIG. 9, the part where the coolant flows is further limited, whereby the cooling efficiency for the power module 7 can be further improved. In a case where the lid member 13 is fixed to the side-wall portions 6b via a seal material, liquid can be used as the coolant flowing through the coolant path 9, whereby the cooling efficiency for the power module 7 can be improved. In a case where the lid member 13 and the heat-dissipation member 6 are formed through integral molding, airtightness of the coolant path 9 is stabilized and the number of components can be decreased. In addition, since members such as screws for fixing the lid member 13 are not needed, the number of components is further decreased, and thus the rotary electric machine 300 can be manufactured at low cost. In a case where the lid member 13 has the projection 6d, formation of disturbance in the coolant path 9 is promoted, whereby the cooling efficiency for the power module 7 can be improved.

### Sixth Embodiment

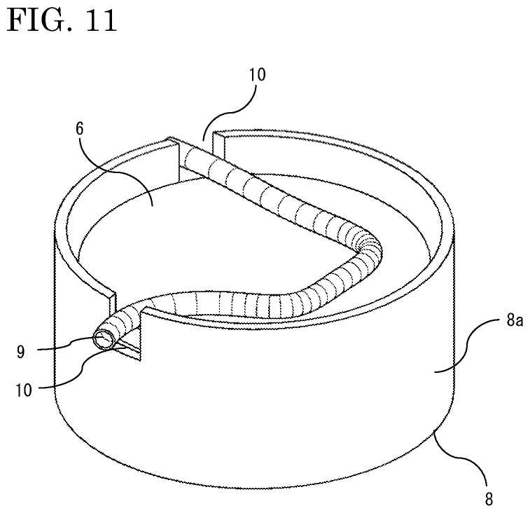

A rotary electric machine 300 according to the sixth embodiment will be described. FIG. 11 is a perspective view showing a heat-dissipation member of the rotary electric machine 300 according to the sixth embodiment, and shows one side in the axial direction. In the rotary electric machine 300 according to the sixth embodiment, the coolant path 9 is provided between two openings 10.

The cover has two openings 10. An inlet for the coolant of the coolant path 9 is provided at one opening 10, and an outlet for the coolant of the coolant path 9 is provided at the other opening 10. The coolant path 9 opens at only the inlet and the outlet. In the present embodiment, the coolant path 9 is a tubular member provided separately from the heat-dissipation member 6. The heat-dissipation member 6 may have positioning portions (not shown) on both sides of the coolant path 9. The positioning portions protrude toward one side in the axial direction from the surface on the one side in the axial direction of the heat-dissipation member 6 and extend along both sides of the coolant path 9. In a case where the heat-dissipation member 6 has the positioning portions, the coolant path 9 provided as a separate body can be easily positioned. Since the coolant path 9 is easily positioned, the coolant path 9 can be easily attached to the heat-dissipation member 6. Since the coolant path 9 is easily attached to the heat-dissipation member 6, productivity of the rotary electric machine 300 can be improved.

As described above, in the rotary electric machine 300 according to the sixth embodiment, the inlet for the coolant of the coolant path 9 is provided at one opening 10, the outlet for the coolant of the coolant path 9 is provided at the other opening 10, and the coolant path 9 opens at only the inlet and the outlet. Therefore, liquid can be used as the coolant of the coolant path 9, and a seal structure is not needed for the coolant path 9. Thus, the number of components of the rotary electric machine 300 can be decreased. Since the number of components of the rotary electric machine 300 is decreased, productivity of the rotary electric machine 300 can be improved.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 front bracket
2 rear bracket
3 rotor
3a field core
3b field winding
4 stator
4a stator core
4b stator winding
5 wiring
5a power-distribution member
Sal conductive wire
6 heat-dissipation member
6a outer circumferential wall
6b side-wall portion
6c protruding portion
6d projection
7 power module
8 cover
8a cylindrical portion
9 coolant path
9a first coolant path
9b second coolant path
9c center line
10 opening
11a fan
11b fan
12 coolant inlet
13 lid member
14 shaft
15 bolt
16 pulley
20 housing
71 bearing
72 bearing
100 electric motor
100a terminal portion
200 power supply unit
200a terminal portion
300 rotary electric machine
W1 cooling wind
W2 cooling wind

What is claimed is:

1. A rotary electric machine comprising:
an electric motor including a rotor which has a field core wound with a field winding and rotates integrally with a rotary shaft, a stator provided on a radially outer side of the rotor and having a stator core wound with a stator winding, and a housing covering outer sides of the field core and the stator core and retaining one end side and another end side of the rotary shaft via bearings;
a power supply unit including a heat-dissipation member which is formed in a plate shape and of which a surface on one side in an axial direction is located on another side in the axial direction of the housing, a power module which has a power semiconductor element for turning on and off current to be supplied to the stator winding and of which a surface on the one side in the axial direction is thermally connected to a surface on the other side in the axial direction of the heat-dissipation member, and a cover formed in a bottomed cylindrical shape and covering the heat-dissipation member and the power module from the other side in the axial direction and a radially outer side, the power supply unit being located on the other side in the axial direction of the housing; and
a coolant path, wherein
a connection portion electrically connecting the electric motor and the power supply unit is provided between the housing and the power supply unit,
a cylindrical portion which is a cylindrical part of the cover extends toward the one side in the axial direction and covers the connection portion from the radially outer side,
the coolant path is provided at one or both of the heat-dissipation member and an area between the heat-dissipation member and the housing,
at least a part of the coolant path overlaps the power module as seen in the axial direction, and
the cylindrical portion of the cover has at least one opening through which a coolant of the coolant path passes, at a circumferential-direction position different from a circumferential-direction position on the radially outer side of the connection portion.

2. The rotary electric machine according to claim 1, wherein
a plurality of the power modules are provided so as to be arranged in the circumferential direction, and
the coolant path extends in the circumferential direction so as to overlap the plurality of the power modules as seen in the axial direction.

3. The rotary electric machine according to claim 2, wherein
the connection portion is provided at one location in the circumferential direction, and
the coolant path extends in the circumferential direction so as to surround the rotary shaft and the connection portion as seen in the axial direction.

4. The rotary electric machine according to claim 1, wherein
the coolant path includes a first coolant path provided at the heat-dissipation member and a second coolant path provided at an area between the heat-dissipation member and the housing, and
a coolant of the first coolant path and a coolant of the second coolant path pass through the same opening.

5. The rotary electric machine according to claim 4, wherein
the coolant of the first coolant path cools the power supply unit, and
the coolant of the second coolant path cools the electric motor.

6. The rotary electric machine according to claim 1, wherein
the opening is a cutout formed by cutting the cylindrical portion from an end on the one side in the axial direction of the cylindrical portion toward the other side in the axial direction.

7. The rotary electric machine according to claim 1, wherein
the cover is made of metal.

8. The rotary electric machine according to claim 1, wherein
the connection portion has a power-distribution member extending in the circumferential direction, and
the opening is provided at a circumferential-direction position different from a circumferential-direction position on the radially outer side of the power-distribution member, in the cylindrical portion.

9. The rotary electric machine according to claim 1, wherein
the rotor has a fan fixed to an end surface on the other side in the axial direction of the field core, and
the housing has, on the other side in the axial direction, at least one coolant inlet through which the coolant flows in.

10. The rotary electric machine according to claim 1, wherein
the power module is provided in a polygonal outer shape as seen in the axial direction, and
the coolant path is formed such that, as seen in the axial direction, a center line of the coolant path crosses one side-line of the power module from an outer side of the power module, to extend on an inner side of the power module, and then crosses another side-line of the power module, to extend on an outer side of the power module.

11. The rotary electric machine according to claim 1, wherein
the heat-dissipation member has two side-wall portions protruding from the surface on the one side in the axial direction toward the one side in the axial direction and extending along the coolant path, thus forming side walls on both sides of the coolant path.

12. The rotary electric machine according to claim 11, wherein
an opening on the one side in the axial direction of the two side-wall portions is covered by a lid member.

13. The rotary electric machine according to claim 12, wherein
the lid member has at least one projection projecting toward the coolant path side.

14. The rotary electric machine according to claim 12, wherein
the lid member is fixed to the side-wall portions via a seal material.

15. The rotary electric machine according to claim 12, wherein
the lid member and the heat-dissipation member are formed through integral molding.

16. The rotary electric machine according to claim 1, wherein
the cover has two said openings,
an inlet for the coolant of the coolant path is provided at one of the openings, and an outlet for the coolant of the coolant path is provided at the other opening, and
the coolant path opens at only the inlet and the outlet.
